(19) United States
(12) Patent Application Publication
(10) Pub. No.: US 2010/0288762 A1
(43) Pub. Date: Nov. 18, 2010

(54) VEHICULAR FUEL TANK FUEL FILLER ORIFICE DEVICE

(75) Inventors: Yusuke Muto, Wako-shi (JP); Yasufumi Yokura, Wako-shi (JP); Shiro Kokubu, Wako-shi (JP)

Correspondence Address: BIRCH STEWART KOLASCH & BIRCH, PO BOX 747, FALLS CHURCH, VA, 22040-0747, US

(73) Assignee: HONDA MOTOR CO., LTD., Tokyo (JP)

(21) Appl. No.: 12/681,292

(22) PCT Filed: Oct. 16, 2008
(86) PCT No.: PCT/JP2008/068713

§ 371 Date: Jul. 16, 2010

(30) Foreign Application Priority Data
Oct. 23, 2007 (JP) 2007-275469

(51) Int. Cl. B60K 15/04

(52) U.S. Cl. 220/86.2; 220/88.2

(57) ABSTRACT

A vehicular fuel tank fuel filler orifice device that is provided with a fuel filler orifice (15a) in an upper wall (3a) of a vehicular fuel tank (3) that stores ethanol fuel as fuel for an engine and a fuel filler guide tube (15) extending from the fuel filler orifice (15a) to the interior of a fuel tank (3) and receiving a fuel filler gun (G), wherein mounted on the fuel filler guide tube (15) are a flame arrestor (21) and a gun stopper (20), the flame arrestor (21) covering a lower opening of the fuel filler guide tube (15) and allowing flow of the fuel but preventing the entrance of flame, and the gun stopper (20) preventing abutment of the fuel filler gun (G) inserted into the fuel filler guide tube (15) against the flame arrestor (21). This enables damage to a flame arrestor by a fuel filler gun inserted into a fuel filler orifice to be prevented without using a long fuel filler guide tube.

### TECHNICAL FIELD

The present invention relates to an improvement of a vehicular fuel tank fuel filler orifice device that is provided with a fuel filler orifice in an upper wall of a vehicular fuel tank that stores ethanol fuel as fuel for an engine and a fuel filler guide tube extending from the fuel filler orifice to the interior of the fuel tank and receiving a fuel filler gun.

### BACKGROUND ART

In recent years, research and development of vehicles using ethanol as fuel have been actively carried out. Within a fuel tank storing ethanol fuel, in a case in which the ethanol concentration is substantially 100%, the air/fuel ratio at normal temperature is often in a combustible range, and for a vehicle equipped with this fuel tank, even in the event that a flame comes close to a fuel filler orifice of the fuel tank for some reason, it is desirable that the flame is prevented from entering the fuel tank.

In general, an automobile is equipped with a device such as a shutter that is retained in a normally closed state in a fuel filler guide tube extending upward from a fuel tank, and that is opened when a fuel filler gun is inserted into the fuel filler guide tube (see Patent Publication 1), and there is therefore no possibility that a flame will enter the fuel tank. However, in a two-wheeled motor vehicle such as a motorbike, in terms of layout of a fuel tank, it is not practical to mount a long fuel filler guide tube on the fuel tank, and it is therefore difficult in practice to provide a shutter, etc. as for an automobile. Patent Publication 1: Japanese Patent Application Laid-open No. 2001-138755

### DISCLOSURE OF INVENTION

### Problems to be Solved by the Invention

The present invention has been accomplished in the light of the above-mentioned circumstances, and it is an object thereof to provide a vehicular fuel tank fuel filler orifice device that, using a flame arrestor, prevents a flame from entering a fuel tank and that can prevent a fuel filler gun inserted into a fuel filler orifice from contacting the flame arrestor without using a long fuel filler guide tube.

### Means for Solving the Problems

In order to attain the above object, according to a first aspect of the present invention, there is provided a vehicular fuel tank fuel filler orifice device that is provided with a fuel filler orifice in an upper wall of a vehicular fuel tank that stores ethanol fuel as fuel for an engine and a fuel filler guide tube extending from the fuel filler orifice to the interior of a fuel tank and receiving a fuel filler gun, characterized in that mounted on the fuel filler guide tube are a flame arrestor and a gun stopper, the flame arrestor covering a lower opening of the fuel filler guide tube and allowing flow of the fuel but preventing the entrance of flame, and the gun stopper preventing abutment of the fuel filler gun inserted into the fuel filler guide tube against the flame arrestor.

According to a second aspect of the present invention, in addition to the first aspect, the flame arrestor is formed so as to have a hollow portion extending downward from the lower end of the fuel filler guide tube, and the gun stopper is disposed in the hollow portion.

According to a third aspect of the present invention, in addition to the first aspect, the gun stopper is formed from a band plate member disposed so that a plate face thereof follows the axial direction of the fuel filler guide tube.

According to a fourth aspect of the present invention, in addition to the third aspect, the gun stopper is formed from two of the band plate members having plate faces parallel to each other and each band plate member has a projection formed by bending, the projections projecting in opposite directions from each other and having a recess on the inside.

According to a fifth aspect of the present invention, in addition to the fourth aspect, the two band plate members are joined via plate faces thereof, and the recesses oppose each other.

According to a sixth aspect of the present invention, in addition to the first aspect, the gun stopper is formed from a plurality of band plate members disposed so as to intersect or be parallel to each other, and a portion, traversing the interior of the fuel filler guide tube, of each band plate member is formed so as to have a cross-section with an upwardly convex inverted V-shape.

According to a seventh aspect of the present invention, in addition to the first aspect, a flame arrestor assembly is formed by joining to an annular mounting plate the flame arrestor, which is formed in a bowl shape with an open upper face, and the gun stopper, which is disposed within the flame arrestor, and the mounting plate is mounted on a lower end part of the fuel filler guide tube.

### EFFECTS OF THE INVENTION

In accordance with the first aspect of the present invention, even in the event that, in a state in which a tank cap is removed, a flame such as a spark enters the fuel filler guide tube, an effect of the flame arrestor, which covers the fuel filler guide tube from below, in preventing the flame from passing through can be expected.

On the other hand, when filling the fuel tank with fuel, even if the fuel filler gun is inserted carelessly into the fuel filler guide tube via the fuel filler orifice, since the extremity of the fuel filler gun abuts against the gun stopper disposed above the flame arrestor it is possible to prevent the fuel filler gun from contacting the flame arrestor. That is, by restricting the depth of insertion of the fuel filler gun into the fuel filler guide tube to a fixed level by the gun stopper, it is possible to protect the flame arrestor while enabling a relatively short fuel filler guide tube to be used.

In accordance with the second aspect of the present invention, since the gun stopper is disposed in the hollow portion of the flame arrestor, the space efficiency increases, and the gun stopper and the flame arrestor can be mounted compactly in a lower end part of the fuel filler guide tube. Moreover, since the gun stopper within the hollow portion occupies a position beneath the fuel filler guide tube, it is possible to suppress a reduction in the flow path area of the fuel filler guide tube by the gun stopper, and reduce the overall fuel flow resistance, thus speeding filling with fuel.

In accordance with the third aspect of the present invention, since the gun stopper is formed from the band plate member, which is disposed so that the plate face follows the axial direction of the fuel filler guide tube, it is possible to give the gun stopper a high strength against an abutment impact force from the fuel filler gun without interfering with the flow of fuel around the gun stopper.

In accordance with the fourth aspect of the present invention, the gun stopper is formed from the two band plate members, which have plate faces parallel to each other, and by forming the projections by bending the band plate members so that the projections project in directions opposite to each other and there are recesses on the inside, it is possible to increase the strength of the gun stopper, guarantee a wide abutment region for the gun stopper against the fuel filler gun, and enhance the function of the gun stopper effectively while reducing the fuel flow resistance.

In accordance with the fifth aspect of the present invention, by disposing the two band plate members forming the gun stopper so that the plate faces thereof are joined together and the recesses thereof oppose each other, it is possible to further increase the strength of the gun stopper, and the mutually opposing recesses form a fuel flow path, thus promoting the passage of fuel.

In accordance with the sixth aspect of the present invention, since an upwardly convex inverted V-shaped cross-sectional shape is given to the main parts of the plurality of band plate members forming the gun stopper, the main parts traversing the interior of the fuel filler guide tube, it is possible to increase the flexural strength of the band plate members, make fuel that has flowed into the fuel filler guide tube flow smoothly down along opposite inclined outside faces of the band plate member, and reduce the fuel flow resistance, thus speeding filling with fuel.

In accordance with the seventh aspect of the present invention, since the flame arrestor assembly is formed from the mounting plate, the flame arrestor, and the gun stopper, and the mounting plate is mounted on the lower end part of the fuel filler guide tube, it is possible to carry out production of the flame arrestor assembly easily without interference from the fuel filler guide tube, thus improving the productivity. Moreover, not only does the flame arrestor, which is formed in a bowl shape with its upper face open, enable a wide fuel flow area to be guaranteed, thus reducing the fuel flow resistance, but it is also possible to make the flame arrestor assembly compact by housing the gun stopper in the hollow portion of the flame arrestor.

### BRIEF DESCRIPTION OF THE DRAWINGS

FIG. 1 is a side view of a two-wheeled motor vehicle equipped with a fuel tank that includes a fuel filler orifice device related to a first embodiment of the present invention (first embodiment).

FIG. 2 is a sectional side view of the fuel tank fuel filler orifice device part of FIG. 1 (first embodiment).

FIG. 3 is an enlarged view of an essential part of FIG. 2 (first embodiment).

FIG. 4 is a sectional view along line 4-4 in FIG. 3 (first embodiment).

FIG. 5 is a view, corresponding to FIG. 3, showing a second embodiment of the present invention (second embodiment).

FIG. 6 is a sectional view along line 6-6 in FIG. 5 (second embodiment).

FIG. 7 is a view, corresponding to FIG. 3, showing a third embodiment of the present invention (third embodiment).

FIG. 8 is a sectional view along line 8-8 in FIG. 7 (third embodiment).

FIG. 9 is a view, corresponding to FIG. 3, showing a fourth embodiment of the present invention (fourth embodiment).

FIG. 10 is a sectional view along line 10-10 in FIG. 9 (fourth embodiment).

FIG. 11 is a view, corresponding to FIG. 3, showing a fifth embodiment of the present invention (fifth embodiment).

FIG. 12 is a sectional view along line 12-12 in FIG. 11 (fifth embodiment).

FIG. 13 is a view, corresponding to FIG. 3, showing a sixth embodiment of the present invention (sixth embodiment).

FIG. 14 is a sectional view along line 14-14 in FIG. 13 (sixth embodiment).

FIG. 15 is a view, corresponding to FIG. 3, showing a seventh embodiment of the present invention (seventh embodiment).

FIG. 16 is a sectional view along line 16-16 in FIG. 15 (seventh embodiment).

FIG. 17 is a view, corresponding to FIG. 15, showing an eighth embodiment of the present invention (eighth embodiment).

FIG. 18 is a sectional view along line 18-18 in FIG. 17 (eighth embodiment).

FIG. 19 is a view, corresponding to FIG. 3, showing a ninth embodiment of the present invention (ninth embodiment).

FIG. 20 is a sectional view along line 20-20 in FIG. 19 (ninth embodiment).

FIG. 21 is a view, corresponding to FIG. 11, showing a tenth embodiment of the present invention (tenth embodiment).

FIG. 22 is a view, corresponding to FIG. 3, showing an eleventh embodiment of the present invention (eleventh embodiment).

FIG. 23 is a view, corresponding to FIG. 3, showing a twelfth embodiment of the present invention (twelfth embodiment).

### EXPLANATION OF REFERENCE NUMERALS AND SYMBOLS

G Fuel filler gun

3 Fuel tank storing ethanol fuel

15 Fuel filler guide tube

17 Flame arrestor assembly

18 Mounting plate

20 Gun stopper

21 Flame arrestor

21a Hollow portion of flame arrestor

22 Band plate member

23 Recess

24 Projection

### BEST MODE FOR CARRYING OUT THE INVENTION

Modes for carrying out the present invention are explained by reference to preferred embodiments shown in the attached drawings.

### Embodiment 1

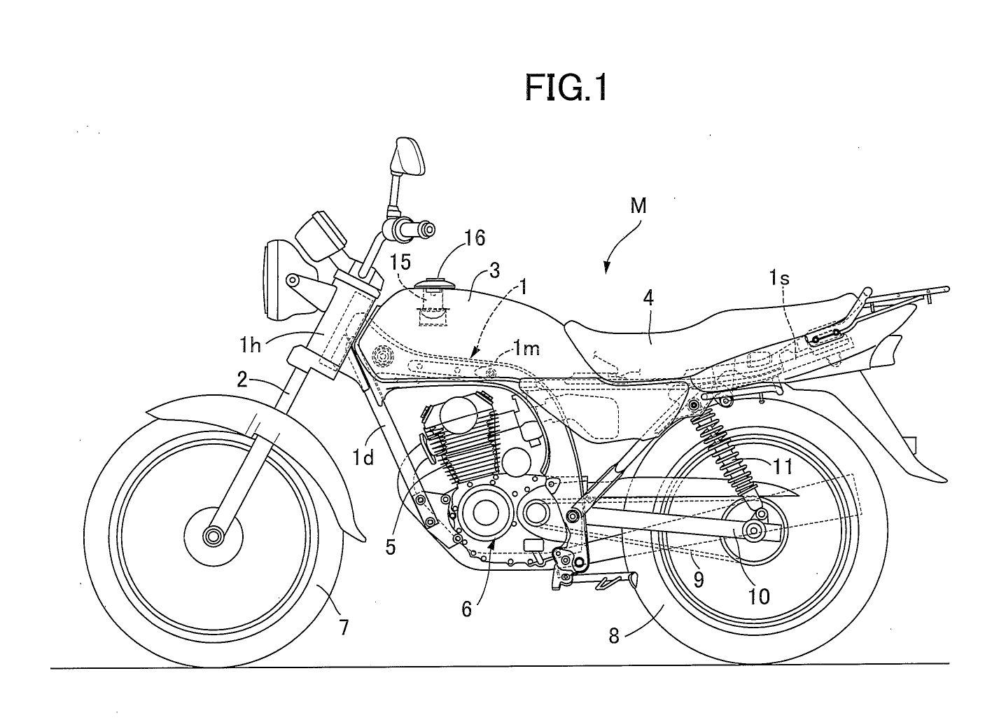

A first embodiment of the present invention shown in FIG. 1 to FIG. 4 is now explained.

In FIG. 1, a vehicle body frame 1 of a two-wheeled motor vehicle M is formed from a head pipe 1h steerably supporting a front fork 2, a main frame 1m extending substantially horizontally rearward from the head pipe 1h and then bending downward, a seat rail is extending substantially horizontally rearward from the rear end of the horizontal portion of the main frame 1m, and a down tube 1d extending obliquely downward from the head pipe 1h; a fuel tank 3 and a seat 4 disposed so as to be connected to the rear of the fuel tank 3 are mounted on the main frame 1m and the seat rail 1s respectively, and a power unit 6 containing an engine 5 disposed immediately below to the fuel tank 3 is mounted between the down tube 1d and the downwardly bent portion of the main frame 1m. A front wheel 7 is axially supported at the lower end of the front fork 2, a rear wheel 8 driven by the power unit 6 via a chain 9 is axially supported at the rear end of a rear fork 10 vertically swingably supported on a lower end part of the main frame 1m, and a rear cushion 11 is disposed between the rear fork 10 and the seat rail 1s.

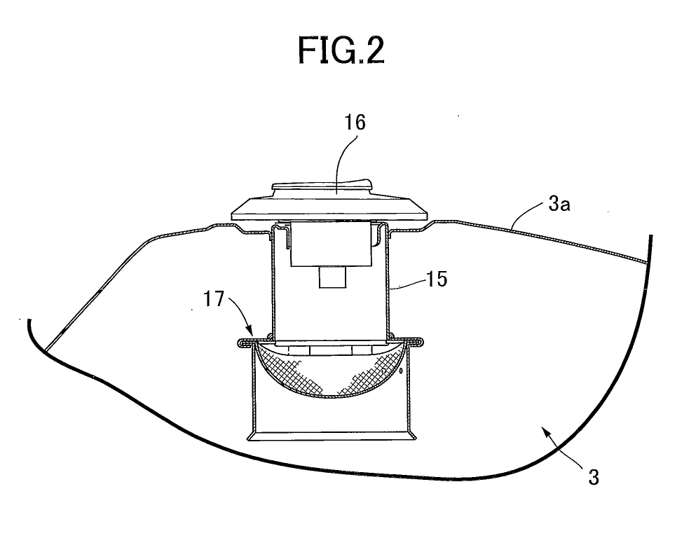

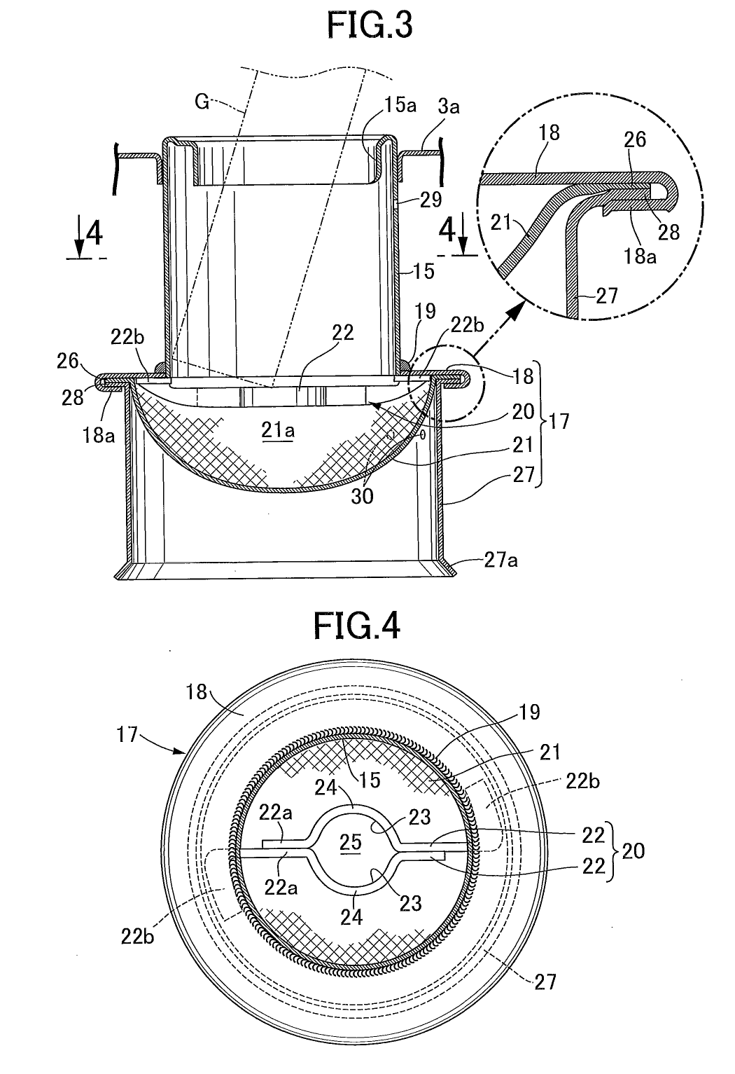

As shown in FIG. 2 and FIG. 3, the fuel tank 3 stores ethanol fuel as fuel for the engine, and a fuel filler guide tube 15 is liquid-tightly welded to its upper wall 3a so as to extend therethrough. An upper end part, projecting from an upper face of the fuel tank 3, of the fuel filler guide tube 15 is bent through 180° into the interior of the fuel filler guide tube 15 along the entire periphery thereof to thus form a fuel filler orifice 15a. This fuel filler orifice 15a is normally closed by a tank cap 16, and when filling with fuel, as shown in FIG. 3, insertion of a fuel filler gun G into the fuel filler guide tube 15 is allowed by removing the tank cap 16.

The majority of the fuel filler guide tube 15 projects into the fuel tank 3, and a flame arrestor assembly 17 is mounted on the peripheral edge of a lower end part of the fuel filler guide tube 15.

This flame arrestor assembly 17 is formed from an annular mounting plate 18 that is mounted on the peripheral edge of the lower end part of the fuel filler guide tube 15 via a weld 19 after producing the assembly 17, a gun stopper 20 welded to a lower face of the mounting plate 18 and disposed so as to traverse a lower opening of the fuel filler guide tube 15, a flame arrestor 21 joined to the lower face of the mounting plate 18 radially outward of the gun stopper 20 and covering the opening at the lower end of the fuel filler guide tube 15 while housing the gun stopper 20, and a cylindrical skirt 27 housing the flame arrestor 21 and extend downward therefrom.

More particularly, as shown in FIG. 3 and FIG. 4, the flame arrestor 21 is formed from two band plate members 22 and 22; these band plate members 22 and 22 are disposed so that a main portion 22a traversing the lower opening of the fuel filler guide tube 15 has its plate face along the axial direction of the fuel filler guide tube 15, are superimposed on each other, and welded. Support pieces 22b and 22b, which are superimposed on the lower face of the mounting plate 18, are formed at one end of one of the band plate members 22 and the other end of the other band plate member 22, and these support pieces 22b and 22b are each welded to the lower face of the mounting plate 18. Projections 24 and 24 are bendingly formed on portions, positioned on the axis of the fuel filler guide tube 15, of the band plate members 22 and 22, the projections 24 and 24 projecting outwardly from each other and having recesses 23 and 23 on the inside, and these projections 24 and 24 are disposed so that the two recesses 23 and 23 on the inside oppose each other to form one passage 25. By so doing, the band plate members 22 and 22 become interchangeable with each other, and may be formed from identical components. The projection 24 is formed in a semicircular shape in the illustrated example, but may be formed in another shape such as a V-shape or an angular U shape.

The flame arrestor 21 allows fuel to pass through but prevents the passage of a flame, and is made of a zinc-plated metal mesh in the illustrated example; individual wires have a diameter of 0.28 mm, and the number of meshes per square inch is 16. This flame arrestor 21 is in a bowl shape with an open upper face in order to define the hollow portion 21a housing the gun stopper 20, and a radially outward flange 26 is formed at the upper end of the flame arrestor 21. In the case of the illustrated example, the bowl shape of the flame arrestor 21 is formed from part of a sphere. The skirt 27 is in a cylindrical shape housing the flame arrestor 21 and extending downward therefrom, a flange 28 is also formed at the upper end thereof, and a funnel portion 27a having its diameter increasing as it goes downward is formed at the lower end of the skirt 27.

The flame arrestor assembly 17 is formed by superimposing the flange 26 and the flange 28 on each other, superimposing them on the lower face of the mounting plate 18, and then sandwiching the flanges 26 and 28 between this mounting plate 18 and a swaging part 18a formed by bending an outer peripheral part of the mounting plate 18 downward and radially inward. After forming this flame arrestor assembly 17, the mounting plate 18 is welded to the lower end part of the fuel filler guide tube 15.

As shown in FIG. 3, a first vent 29 is provided in an upper part of a peripheral wall of the fuel filler guide tube 15, the first vent 29 providing communication between the interior and exterior of the fuel filler guide tube 15, and a second vent 30 is also provided in an upper part of a peripheral wall of the skirt 27, the second vent 30 providing communication between the interior and exterior of the skirt 27. In this arrangement, the second vent 30 is either formed so as to have a larger diameter than that of the first vent 29 or so that the number thereof is larger than that of the first vent 29.

The operation of the first embodiment is now explained.

In a state in which the tank cap 16 is removed, even in the event that a flame such as a spark enters the fuel filler guide tube 15, an effect of the flame arrestor 21 in preventing the flame from passing through can be expected.

Moreover, since the skirt 27 is provided so as to be connected to the lower end of the fuel filler guide tube 15, the skirt 27 extending beneath the flame arrestor 21 while surrounding the flame arrestor 21 along the entire periphery, it is possible by means of the skirt 27 to prevent the occurrence of air convection between the interior of the fuel filler guide tube 15 and an upper part of the interior of the fuel tank 3 occurring via of the flame arrestor 21.

In order to achieve more effective prevention of convection by the skirt 27, providing the funnel portion 27a, which increases in diameter as it goes downward, in the lower end part of the skirt 27, or setting the axial length of the skirt 27 so as to be substantially twice the axial length of the flame arrestor 21 or greater is effective.

On the other hand, when filling the fuel tank 3 with fuel, even if the fuel filler gun G is carelessly inserted into the fuel filler guide tube 15 via the fuel filler orifice 15a, since the extremity of the fuel filler gun G abuts against the gun stopper 20 disposed above the flame arrestor 21, it is possible to prevent the fuel filler gun G from contacting the flame arrestor 21. In this way, since the depth of insertion of the fuel filler gun G into the fuel filler guide tube 15 is restricted to a fixed level by the gun stopper 20, it is possible to protect the flame arrestor 21 while enable the use of a relatively short fuel filler guide tube 15.

Furthermore, since the flame arrestor 21 is in the bowl shape that has a larger diameter than that of the fuel filler guide tube 15, it is possible to guarantee a wide fluid flow area, and when filling with fuel, replacement of air discharged from the fuel tank 3 to the fuel filler guide tube 15 side with fuel flowing into the fuel tank 3 side from the fuel filler guide tube 15 is smoothly carried out in the flame arrestor 21, thus speeding the filling with fuel.

Moreover, since the flame arrestor 21, which is in the bowl shape with the open upper face, has the hollow portion 21a extending downward from the lower end of the fuel filler guide tube 15, and the gun stopper 20 is disposed in the hollow portion 21a, the space efficiency is improved, and the gun stopper 20 and the flame arrestor 21 can be mounted on the lower end part of the fuel filler guide tube 15 compactly. Furthermore, since the gun stopper 20 within the hollow portion 21a occupies the position beneath the fuel filler guide tube 15, it is possible to suppress any reduction in the flow path area of the fuel filler guide tube 15 due to the gun stopper 20, and decrease the overall fuel flow resistance, thus speeding filling with fuel.

Furthermore, since the gun stopper 20 is formed from the band plate member 22, which is disposed so that its plate face follows the axial direction of the fuel filler guide tube 15, it is possible to give the gun stopper 20 a high strength against an abutment impact force from the fuel filler gun G without interfering with the flow of fuel around the gun stopper 20.

In this arrangement, particularly since the gun stopper 20 is formed from the two band plate members 22 and 22 having their plate faces parallel to each other, and the projection 24 is formed by bending the band plate members 22 so that they project in opposite directions from each other with the recesses 23 on the inside, it is possible to increase the strength of the gun stopper 20, guarantee a wide abutment region for the gun stopper 20 against the fuel filler gun G, and enhance the function of the gun stopper 20.

Furthermore, since the two band plate members 22 and 22 forming the gun stopper 20 are disposed so that their plate faces are joined together and the recesses 23 and 23 oppose each other, it is possible to increase the strength of the gun stopper 20 effectively by joining the two band plate members 22 and 22, and since the mutually opposing recesses 23 and 23 form a fuel flow path, the passage of fuel can be promoted. By joining the two band plate members 22 and 22, it is only necessary to form one of the pair of support pieces 22b and 22b for mounting the gun stopper 20 on the mounting plate 18 on each of the mutually opposite end parts of the two band plate members 22 and 22, thus simplifying the mounting structure of the gun stopper 20.

Since the first vent 29 and the second vent 30 are provided in the upper part of the peripheral wall of the fuel filler guide tube 15 and the upper part of the peripheral wall of the skirt 27 respectively, and the second vent 30 is formed so as to have a larger diameter than that of the first vent 29 or so that the number thereof is larger than that of the first vent 29, when the fuel level within the fuel tank 3 increases above the level of the lower end face of the skirt 27 accompanying filling of the fuel tank 3 with fuel, air in an upper part within the fuel tank 3 flows smoothly outward via the first and second vents 29 and 30, thereby preventing any decrease in the speed at which the fuel tank 3 is filled with fuel. Furthermore, when the fuel level within the fuel tank 3 increases beyond the level of the second vent 30, outflow of air in the upper part within the fuel tank 3 to the outside is throttled by the first vent 29, the fuel level within the fuel filler guide tube 15 increases rapidly accompanying filling with fuel, and a fuel-filling operator realizes that the fuel tank 3 is full on seeing this state and stops the fuel-filling operation. Subsequently, air in the upper part within the fuel tank 3 gradually flows to the outside via the first vent 29, and the fuel level within the fuel filler guide tube 15 slowly decreases and reaches the same level as the fuel level within fuel tank 3. It is thus possible to prevent excessive filling of the fuel tank 3 with fuel.

In such a vehicular fuel tank fuel filler orifice device, since the flame arrestor assembly 17 is formed by welding the gun stopper 20 to the mounting plate 18 and swaging the flame arrestor 21 and the skirt 27, and the mounting plate 18 is joined by welding to the lower end part of the fuel filler guide tube 15, it is possible to produce the flame arrestor assembly 17 easily without interference from the fuel filler guide tube 15, thus contributing to an improvement in productivity.

### Embodiment 2

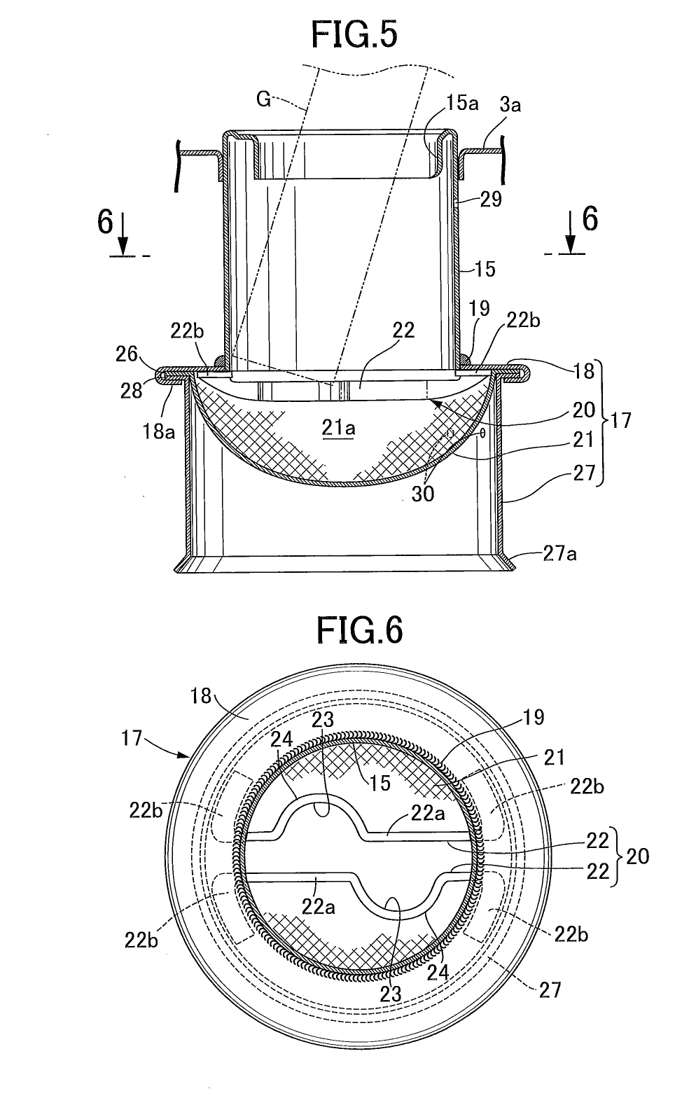

A second embodiment of the present invention shown in FIG. 5 and FIG. 6 is now explained.

In this second embodiment, a pair of support pieces 22b and 22b are formed at opposite ends of each of two band plate members 22 and 22 forming a gun stopper 20, and projections 24 and 24 of each of the band plate members 22 and 22 are offset from each other in opposite directions from the axis of a fuel filler guide tube 15; these two band plate members 22 and 22 are spaced from each other, and the pair of support pieces 22b and 22b of each of the band plate members 22 and 22 are welded to a lower face of a mounting plate 18. Since the arrangement is otherwise the same as the preceding embodiment, parts in FIG. 5 and FIG. 6 corresponding to those of the preceding embodiment are denoted by the same reference numerals and symbols, and duplication of the explanation is omitted.

In accordance with the second embodiment, the number of support pieces 22b of the band plate members 22 and 22 forming the gun stopper 20 increases compared with the preceding embodiment, but an abutment region of the gun stopper 20 against a fuel filler gun G can be widened.

### Embodiment 3

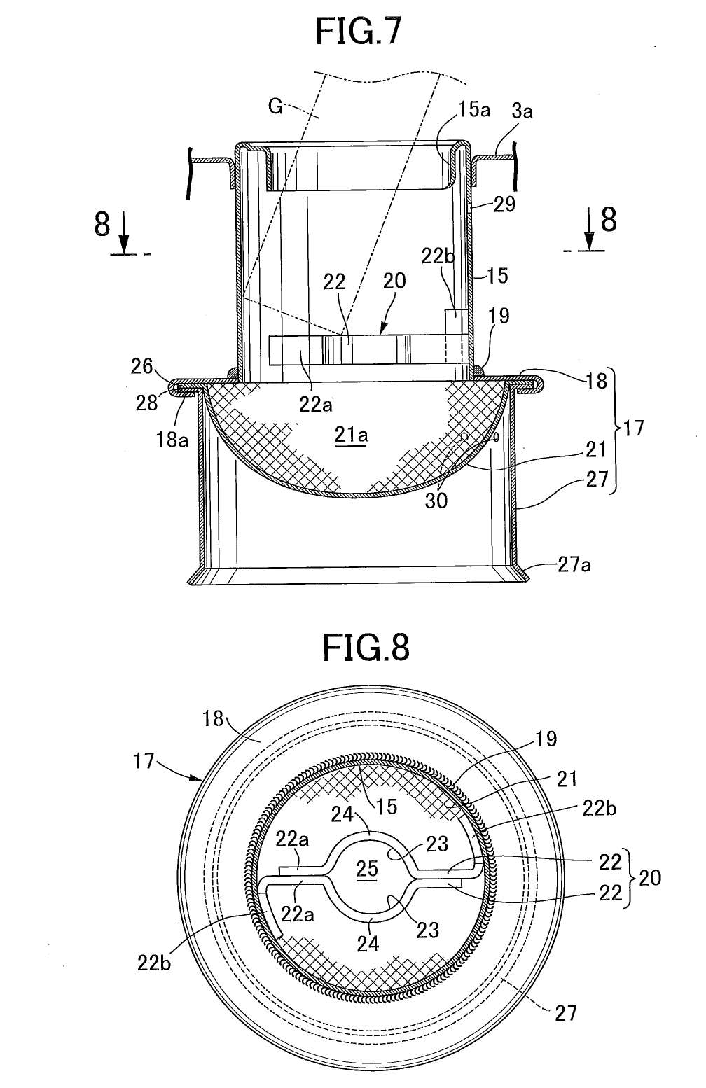

A third embodiment of the present invention shown in FIG. 7 and FIG. 8 is an arrangement in which a pair of support pieces 22b and 22b of two band plate members 22 and 22 forming a gun stopper 20 as in the first embodiment are formed so as to follow the inner peripheral face of a fuel filler guide tube 15, and are secured by welding to the inner peripheral face of a lower part of the fuel filler guide tube 15. Since the arrangement is otherwise the same as the first embodiment, parts in FIG. 7 and FIG. 8 corresponding to those of the first embodiment are denoted by the same reference numerals and symbols, and duplication of the explanation is omitted.

In the case of the third embodiment, a flame arrestor assembly 17 is formed from three components, that is, a mounting plate 18, a flame arrestor 21, and a skirt 27.

### Embodiment 4

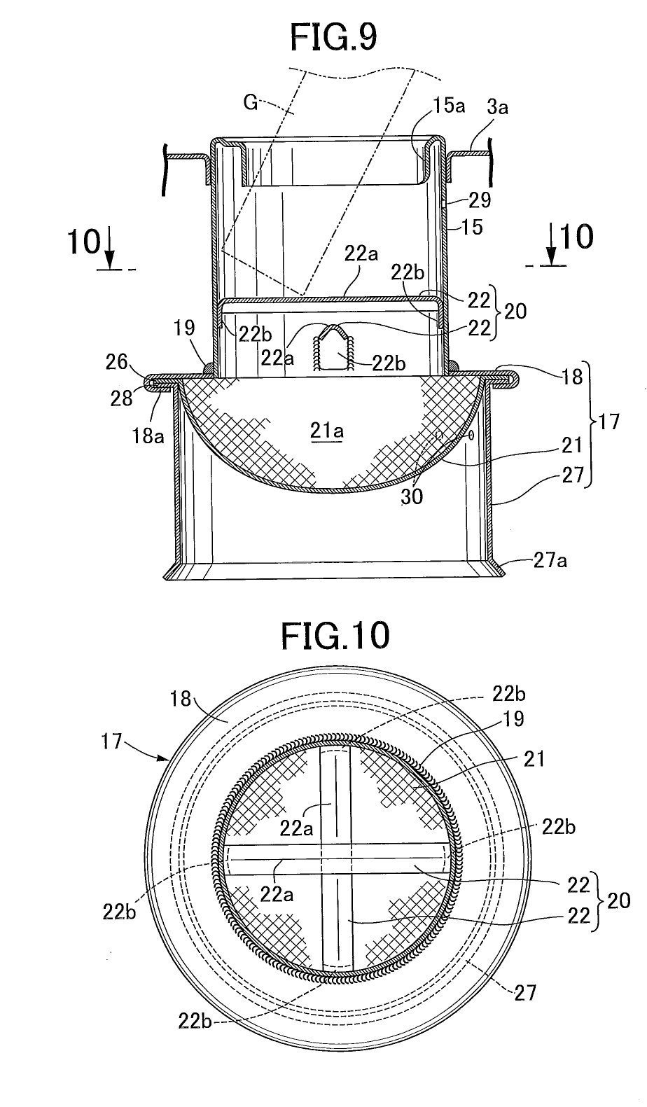

A fourth embodiment of the present invention shown in FIG. 9 and FIG. 10 is now explained.

In this fourth embodiment, provided on each of two band plate members 22 and 22 forming a gun stopper 20 are a main portion 22a having an upwardly convex inverted V-shaped cross-section and a pair of flat, plate-form support pieces 22b and 22b bending downward from opposite ends of the main portion 22a; these two band plate members 22 and 22 are mounted so that the main portions 22a are disposed so as to intersect each other in a cross shape when viewed from above a fuel filler guide tube 15, and the support pieces 22b and 22b are welded to the inner peripheral face of a lower part of the fuel filler guide tube 15. Since the arrangement apart from the gun stopper 20 is the same as the first embodiment, parts in FIG. 9 and FIG. 10 corresponding to those of the first embodiment are denoted by the same reference numerals and symbols, and duplication of the explanation is omitted.

In accordance with this fourth embodiment, since the two band plate members 22 and 22 forming the gun stopper 20 are disposed so that when viewed from above they intersect each other in a cross shape within the fuel filler guide tube 15, it is possible to widen an abutment region of the gun stopper 20 against a fuel filler gun G. Moreover, since the main portion 22a, traversing the interior of the fuel filler guide tube 15, of each of the band plate members 22 and 22 is given an upwardly convex inverted V-shaped cross-section, it is possible to increase the flexural strength of each of the band plate members 22 and 22, make fuel that has flowed into the fuel filler guide tube 15 flow down smoothly along opposite inclined outside faces of each of the band plate members 22 and 22, and reduce the fuel flow resistance, thus speeding filling with fuel.

### Embodiment 5

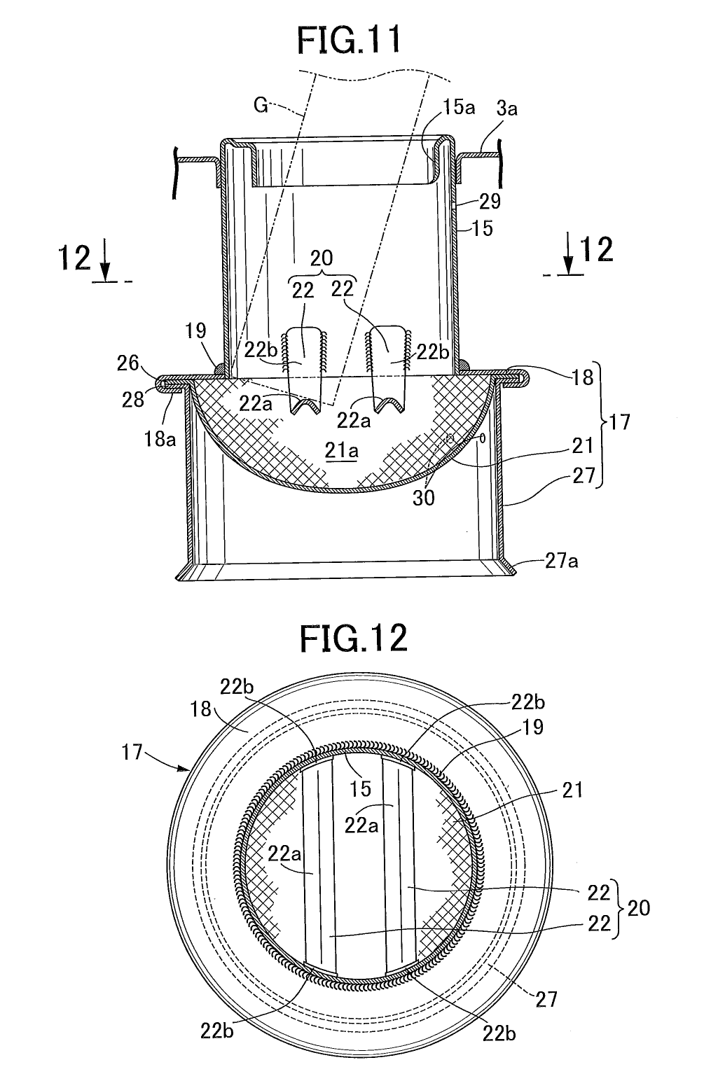

A fifth embodiment of the present invention shown in FIG. 11 and FIG. 12 is now explained.

In this fifth embodiment, provided on each of two band plate members 22 and 22 forming a gun stopper 20 are a main portion 22a having an upwardly convex inverted V-shaped cross-section and a pair of flat, plate-form support pieces 22b and 22b bending upward from opposite ends of the main portion 22a; these two band plate members 22 and 22 are mounted so that the main portions 22a are disposed in a hollow portion 21a of a bowl-shaped flame arrestor 21 parallel to each other with a constant spacing, and the support pieces 22b and 22b are welded to the inner peripheral face of a lower part of a fuel filler guide tube 15. Since the arrangement apart from the gun stopper 20 is the same as the first embodiment, parts in FIG. 9 and FIG. 10 corresponding to those of the first embodiment are denoted by the same reference numerals and symbols, and duplication of the explanation is omitted.

In accordance with the fifth embodiment, in addition to the same operational effects as in the fourth embodiment being achieved, since the main portion 22a of each of the band plate members 22 and 22 is disposed in the hollow portion 21a of the flame arrestor 21, which has a larger diameter than that of the fuel filler guide tube 15, it is possible to suppress the reduction in flow path area of the fuel filler guide tube 15 due to the gun stopper 20, and decrease the overall fuel flow resistance.

### Embodiment 6

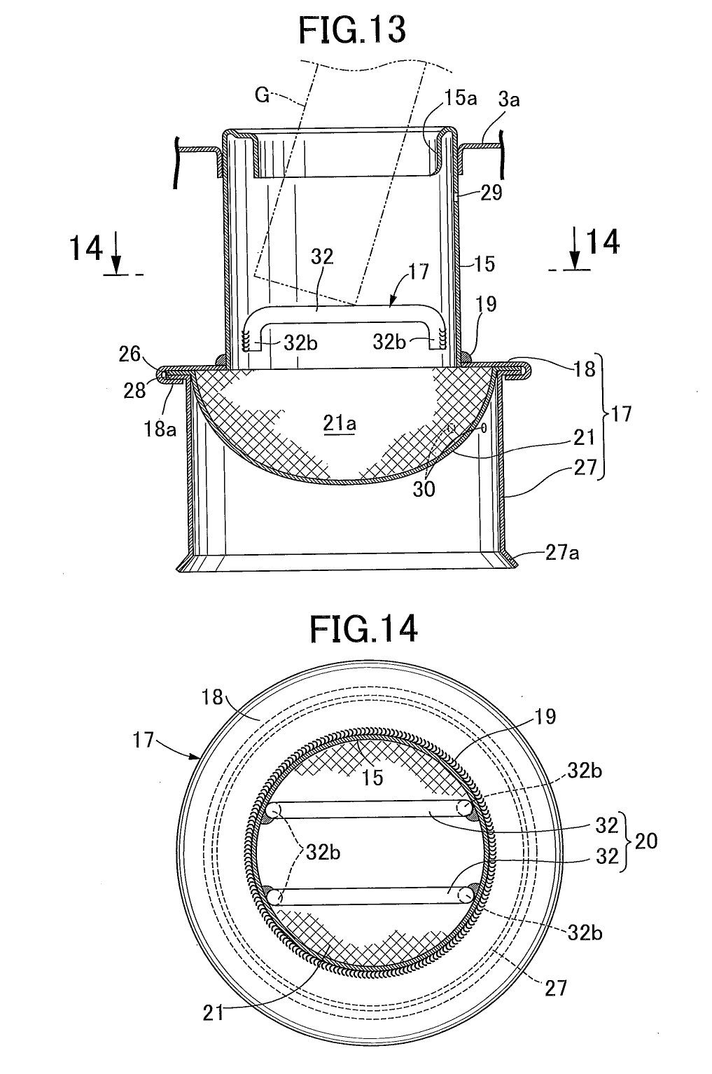

A sixth embodiment of the present invention shown in FIG. 13 and FIG. 14 is now explained.

In this sixth embodiment, a gun stopper 20 is formed from two round bar members 32 and 32; these round bar members 32 and 32 are disposed so as to traverse a lower part of the interior of a fuel filler guide tube 15 while being arranged parallel to each other with a constant spacing, and support pieces 32a, 32a; 32a, 32a formed by bending downward or upward opposite end parts of each of the round bar members 32 and 32 are mounted by welding to the inner peripheral face of a lower part of the fuel filler guide tube 15. Since the arrangement apart from the gun stopper 20 is the same as the first embodiment, parts in FIG. 13 and FIG. 14 corresponding to those of the first embodiment are denoted by the same reference numerals and symbols, and duplication of the explanation is omitted.

In accordance with this sixth embodiment, since the round bar members 32 and 32 have a circular cross-section, the flexural strength is high, and fuel that has flowed into the fuel filler guide tube 15 can be made to flow down along a smooth cylindrical face of the round bar members 32 and 32, thus reducing the fuel flow resistance and thereby speeding filling with fuel.

### Embodiment 7

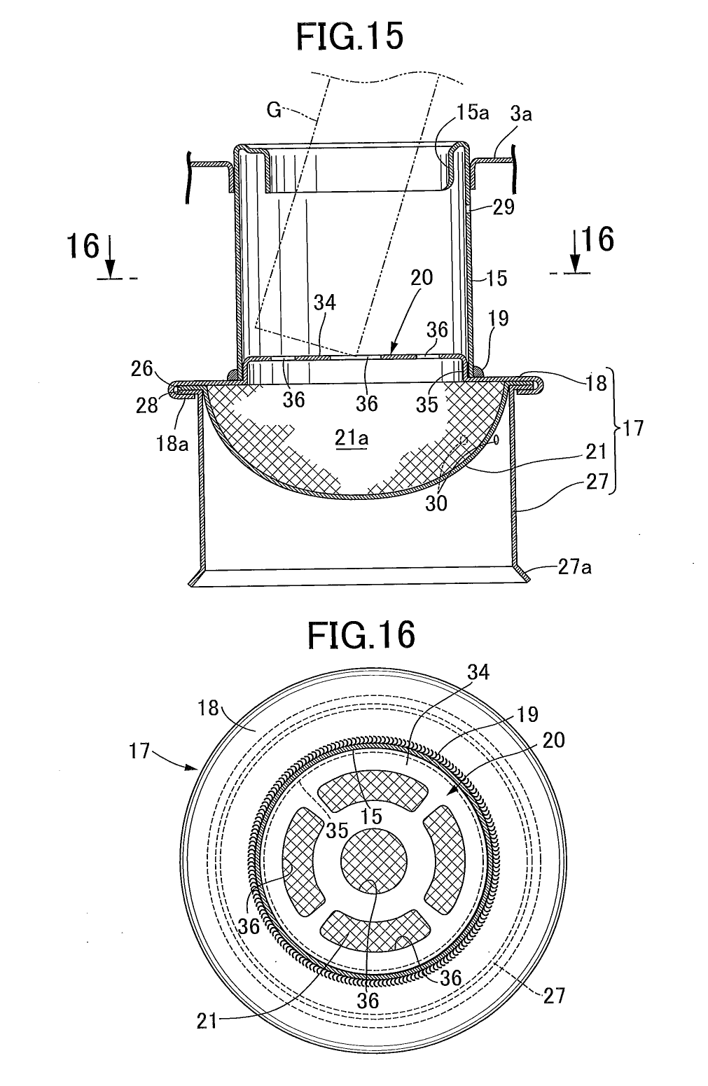

A seventh embodiment of the present invention shown in FIG. 15 and FIG. 16 is now explained.

In this seventh embodiment, a gun stopper 20 formed from a disk portion 34 and an annular wall part 35 bending downward from the outer peripheral edge of the disk portion 34 is provided in a mounting plate 18 of a flame arrestor assembly 17 so as to be connected to and integral with the mounting plate 18, and a large number of through holes 36 allowing the passage of fuel flowing into a fuel filler guide tube 15 are bored in the disk portion 34. The annular wall part 35 is fitted into the inner peripheral face of a lower end part of the fuel filler guide tube 15. Since the arrangement apart from the gun stopper 20 is the same as the first embodiment, parts in FIG. 15 and FIG. 16 corresponding to those of the first embodiment are denoted by the same reference numerals and symbols, and duplication of the explanation is omitted.

In accordance with this seventh embodiment, a special step for mounting the gun stopper 20 on the mounting plate 18 is naturally eliminated due to integration of the mounting plate 18 of the flame arrestor assembly 17 and the gun stopper 20. Moreover, since the annular wall part 35 of the gun stopper 20 is fitted into the inner peripheral face of the lower end part of the fuel filler guide tube 15, the coaxial precision between the fuel filler guide tube 15 and the flame arrestor assembly 17 can easily be enhanced. Moreover, the annular wall part 35 contributes to an increase in the rigidity of the gun stopper 20, and not only can deformation thereof due to an abutment impact from the fuel filler gun G be prevented, but also the occurrence of distortion of a weld 19 between the fuel filler guide tube 15 and the mounting plate 18 due to the deformation can be prevented, thus contributing to an improvement in the durability of the weld 19.

### Embodiment 8

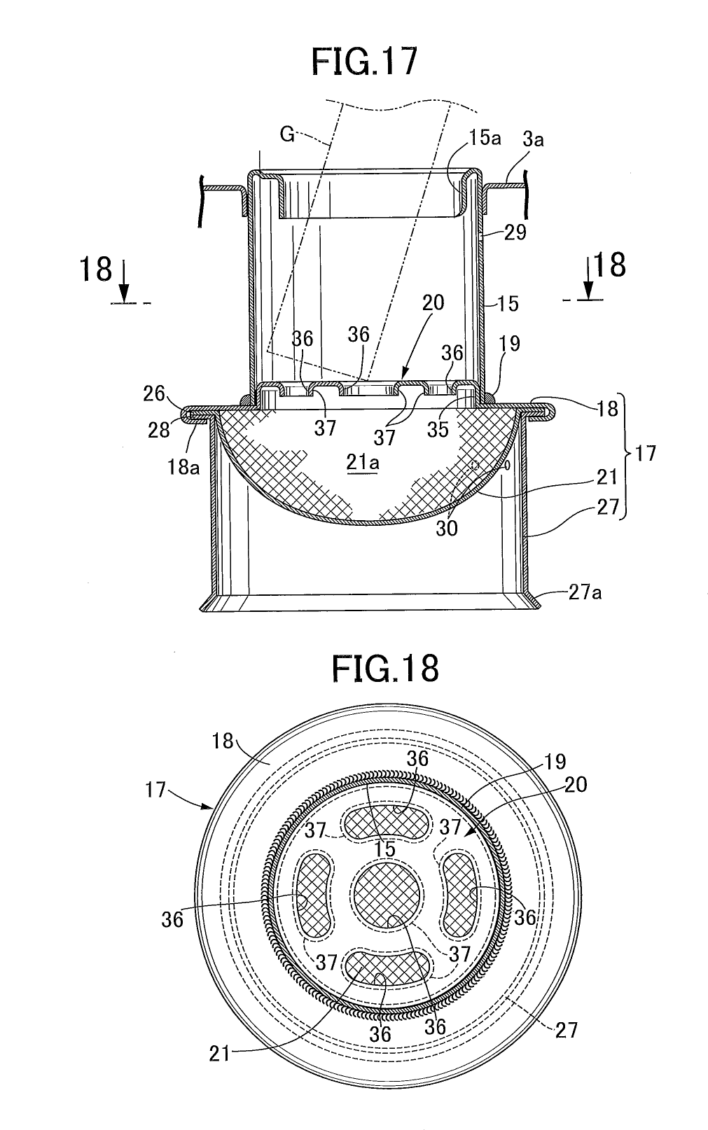

An eighth embodiment of the present invention shown in FIG. 17 and FIG. 18 is an arrangement in which a large number of annular ribs 37 are formed on the gun stopper 20 in the seventh embodiment so as to project downward from the peripheral edge of the large number of through holes 36; parts in FIG. 17 and FIG. 18 corresponding to those of the seventh embodiment are denoted by the same reference numerals and symbols, and duplication of the explanation is omitted.

In accordance with this eighth embodiment, the annular ribs 37 on the peripheral edge of the through holes 36 enhance the rigidity of the disk-shaped gun stopper 20, and smoothly guide downward flow of fuel passing through the through holes 36.

### Embodiment 9

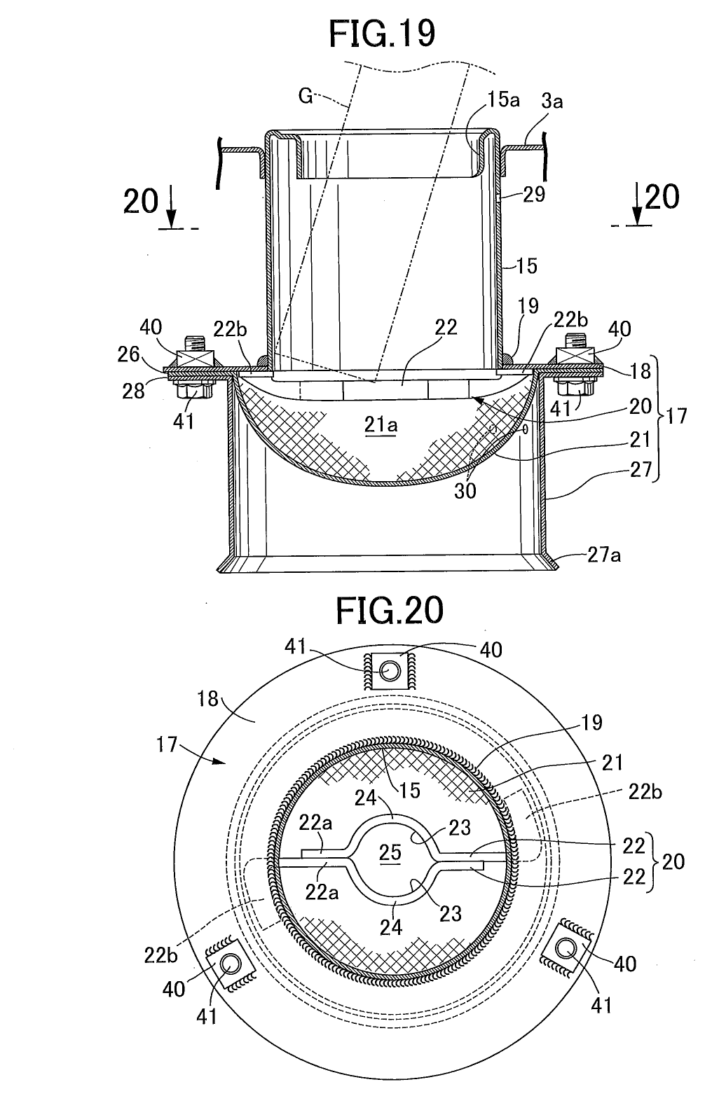

A ninth embodiment of the present invention shown in FIG. 19 and FIG. 20 is now explained.

In accordance with this ninth embodiment, instead of swaging when forming the flame arrestor assembly 17 of each of the above embodiments, three components, that is, a mounting plate 18, a flange 26 of a flame arrestor 21, and a flange 28 of a skirt 27, are joined by means of a plurality of weld nuts 40 and bolts 41. In this case, a gun stopper 20 is mounted on, for example, a lower face of the mounting plate 18 as in the first embodiment of FIG. 3. Since the arrangement is otherwise the same as the first embodiment, parts in FIG. 19 and FIG. 20 corresponding to those of the first embodiment are denoted by the same reference numerals and symbols, and duplication of the explanation is omitted.

### Embodiment 10

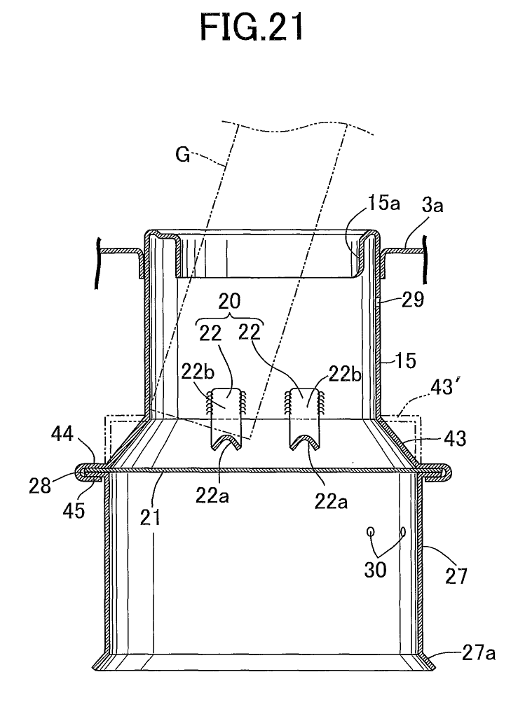

A tenth embodiment of the present invention shown in FIG. 21 is now explained.

In this tenth embodiment, provided so as to be connected to the lower end of a fuel filler guide tube 15 is a tapered portion 43 that increases in diameter as it goes downward or a large-diameter cylindrical part 43′ having a larger diameter than that of the fuel filler guide tube 15. Provided in each of two band plate members 22 and 22 forming a gun stopper 20 as in the fifth embodiment of FIG. 11 and FIG. 12 are a main portion 22a having an upwardly convex inverted V-shaped cross-section and a pair of flat, plate-form support pieces 22b and 22b bending upward from opposite ends of the main portion 22a; these two band plate members 22 and 22 are disposed in the tapered part 43 or the large-diameter cylindrical part 43′ so that the main portions 22a are parallel to each other with a constant spacing, and the support pieces 22b and 22b are welded to the inner peripheral face of a lower part of the fuel filler guide tube 15.

A mounting flange 44 and a swaging part 45 connected to the outer peripheral end thereof are provided integrally with the lower end of the tapered part 43 or the large-diameter cylindrical part 43′; by superimposing in sequence on a lower face of the mounting flange 44 a flat, plate-form flame metal mesh arrestor 21 and a flange 28 at the upper end of a skirt 27, and swaging the swaging part 45, the flame arrestor 21 and the skirt 27 are joined to the tapered part 43 or the large-diameter cylindrical part 43′.

In accordance with this tenth embodiment, providing the tapered part 43 or the large-diameter cylindrical part 43′ so as to be connected to the lower end of the fuel filler guide tube 15 enables the flat, plate-form flame arrestor 21 having a larger diameter than that of the fuel filler guide tube 15 to be used, thus reducing the fuel flow resistance of the flame arrestor 21. Moreover, since the main portion 22a of each of the band plate members 22 and 22 of the gun stopper 20 is disposed within the tapered part 43 or the large-diameter cylindrical part 43′, which is wider than the interior of the fuel filler guide tube 15, it is possible to suppress any decrease in the flow path area of the fuel filler guide tube 15 due to the gun stopper 20, thus reducing the overall fuel flow resistance.

### Embodiment 11

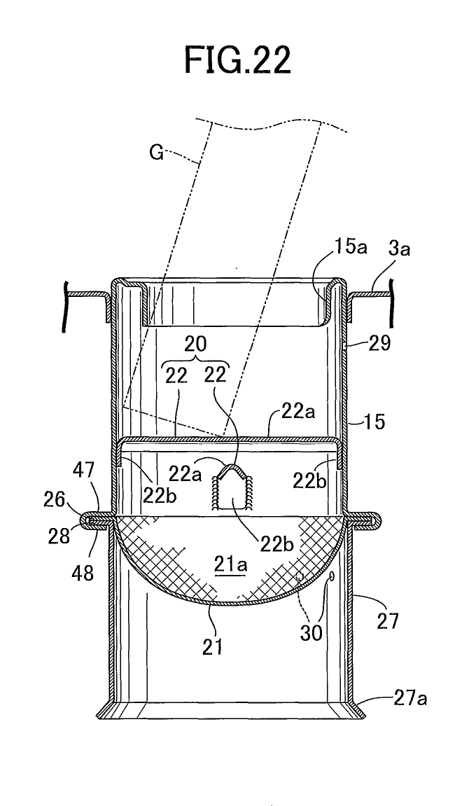

An eleventh embodiment of the present invention shown in FIG. 22 is now explained.

In this eleventh embodiment, a mounting flange 47 and a swaging part 48 connected to the outer peripheral end thereof are provided integrally with a lower end part of a fuel filler guide tube 15; by superimposing in sequence on a lower face of the mounting flange 47 a flange 26 of a flame arrestor 21 having a bowl shape with an open upper face and a flange 28 of a skirt 27, and swaging the swaging part 48, the flame arrestor 21 and the skirt 27 are mounted on the fuel filler guide tube 15. In this case, a gun stopper 20 is, for example, mounted in advance on the inner peripheral face of a lower end part of the fuel filler guide tube 15 as in the fourth embodiment of FIG. 9 and FIG. 10. Since the arrangement is otherwise the same as the fourth embodiment, parts in FIG. 22 corresponding to those of the fourth embodiment are denoted by the same reference numerals and symbols, and duplication of the explanation is omitted.

In accordance with this eleventh embodiment, the gun stopper 20 and the skirt 27 can be joined to the fuel filler guide tube 15 by the mounting flange 47 and the swaging part 48 in the lower end part of the fuel filler guide tube 15, and it is possible to omit the mounting plate 18 as in the first embodiment, thus simplifying the structure and the machining.

### Embodiment 12

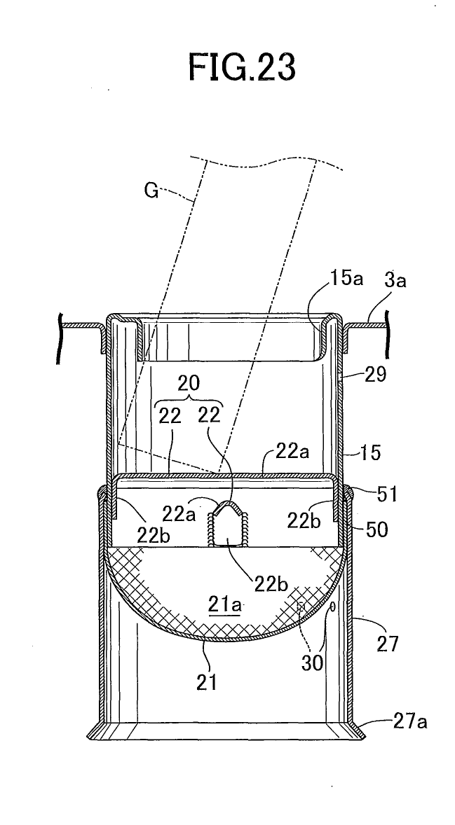

Finally, a twelfth embodiment of the present invention shown in FIG. 23 is explained.

In this twelfth embodiment, a connecting cylindrical part 50 is formed in an upper end part of a flame arrestor 21 having a bowl shape with an open upper face; this connecting cylindrical part 50 and an upper end part of a skirt 27 fitted around the outer peripheral face of the connecting cylindrical part 50 are fitted onto the outer peripheral face of a lower end part of a fuel filler guide tube 15, and both the connecting cylindrical part 50 and the skirt 27 are joined to the lower end part of the fuel filler guide tube 15 via a weld 51. In this case also, a gun stopper 20 is, for example, mounted in advance on the inner peripheral face of the lower end part of the fuel filler guide tube 15 as in the fourth embodiment of FIG. 9 and FIG. 10. Since the arrangement is otherwise the same as the fourth embodiment, parts in FIG. 23 corresponding to those of the fourth embodiment are denoted by the same reference numerals and symbols, and duplication of the explanation is omitted.

In accordance with this twelfth embodiment, the gun stopper 20 and the skirt 27 can be joined to the fuel filler guide tube 15 via the same weld 51, and it is possible to omit the mounting plate 18 as in the first embodiment, thus simplifying the structure and the machining.

Embodiments of the present invention are explained above, but the present invention is not limited to the above-mentioned embodiments, and may be modified in a variety of ways as long as the modifications do not depart from the spirit and scope of the present invention. For example, the number of band plate members 22 or round bar members 32 forming the gun stopper 20 is not limited to two, and may be selected appropriately according to the size of the fuel filler guide tube 15.

1-7. (canceled)

8. A vehicular fuel tank fuel filler orifice device that is provided with a fuel filler orifice (15a) in an upper wall (3a) of a vehicular fuel tank (3) that stores ethanol fuel as fuel for an engine and a fuel filler guide tube (15) extending from the fuel filler orifice (15a) to the interior of a fuel tank (3) and receiving a fuel filler gun (G),
characterized in that mounted on the fuel filler guide tube (15) are a flame arrestor (21) and a gun stopper (20), the flame arrestor (21) covering a lower opening of the fuel filler guide tube (15) and allowing flow of the fuel but preventing the entrance of flame, and the gun stopper (20) preventing abutment of the fuel filler gun (G) inserted into the fuel filler guide tube (15) against the flame arrestor (21), the flame arrestor (21) is formed so as to have a hollow portion (21a) extending downward from the lower end of the fuel filler guide tube (15), and the gun stopper (20) is disposed in the hollow portion (21a).

9. The vehicular fuel tank fuel filler orifice device according to claim 8,
wherein the gun stopper (20) is formed from a band plate member (22) disposed so that a plate face thereof follows the axial direction of the fuel filler guide tube (15).

10. The vehicular fuel tank fuel filler orifice device according to claim 9,
wherein the gun stopper (20) is formed from two of the band plate members (22) having plate faces parallel to each other and each band plate member (22) has a projection (24) formed by bending, the projections (24) projecting in opposite directions from each other and having a recess (23) on the inside.

11. The vehicular fuel tank fuel filler orifice device according to claim 10,
wherein the two band plate members (22) are joined via plate faces thereof, and the recesses (23) oppose each other.

12. The vehicular fuel tank fuel filler orifice device according to claim 8,
wherein the gun stopper (20) is formed from a plurality of band plate members (22) disposed so as to intersect or be parallel to each other, and a portion, traversing the interior of the fuel filler guide tube (15), of each band plate member (22) is formed so as to have a cross-section with an upwardly convex inverted V-shape.

13. The vehicular fuel tank fuel filler orifice device according to claim 8,
wherein a flame arrestor assembly (17) is formed by joining to an annular mounting plate (18) the flame arrestor (21), which is formed in a bowl shape with an open upper face, and the gun stopper (20), which is disposed within the flame arrestor (21), and the mounting plate (18) is mounted on a lower end part of the fuel filler guide tube (15).
